(19) United States
(12) Patent Application Publication
(10) Pub. No.: US 2006/0070799 A1
(43) Pub. Date: Apr. 6, 2006

(54) Harness attached to air tank of self-contained breathing apparatus and provided with added hand loop

(75) Inventors: William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 11/284,532

(22) Filed: Nov. 21, 2005

Related U.S. Application Data
(62) Division of application No. 10/725,068, filed on Dec. 1, 2003.

(51) Int. Cl. A62B 35/00

(52) U.S. Cl. 182/3

(57) ABSTRACT

For a firefighter or another person who may need to work in a hazardous environment, such as a rescue or chemical worker, a harness attached to an air tank of a self-contained breathing apparatus so as to enable a person wearing the harness to carry the air tank on his or her back includes, at an upper portion of the harness, a hand loop, by which a rescuer can drag a person wearing the harness, if the person has become incapacitated. Preferably, the hand loop and the shoulder straps are fabric straps, which are sewn to one another.

### CROSS-REFERENCE TO RELATED APPLICATIONS

This application is a division of U.S. patent application Ser. No. 10/725,068, which was filed on Dec. 1, 2003.

### TECHNICAL FIELD OF THE INVENTION

This invention pertains to a harness, which is attached to an air tank of a self-contained breathing apparatus so as to enable a person wearing the harness to carry the air tank. This invention contemplates that the harness includes a hand loop, by which a rescuer can drag a person wearing the harness.

### BACKGROUND OF THE INVENTION

Under certain circumstances, a firefighter or another person who may need to work in a hazardous environment, such as a rescue or chemical worker, may wear a harness of a specific type, which is worn, usually, over a coat worn by the firefighter or other person wearing the harness, and to which an air tank of a self-contained breathing apparatus (SCBA) is attachable so as to enable the person wearing the harness to carry the air tank on his or her back. It is convenient to refer to such a harness as an SCBA harness.

Under other circumstances, a firefighter or another person, who may need to work in a hazardous environment, such as a rescue or chemical worker, also may wear a second harness of a different type, which is deployed within a coat worn by the firefighter or other person wearing the second harness, and which provides a hand loop. A rescuer can grasp the hand loop to drag the firefighter or other person from a hazardous location, if the firefighter or other person becomes incapacitated. It is convenient to refer to such a harness as a drag harness.

### SUMMARY OF THE INVENTION

Advantageously, this invention combines the utility of an SCBA harness, as described above, and the utility of a drag harness, as described above, essentially by providing an SCBA harness with a hand grip, by which a rescuer can drag a person wearing the SCBA harness provided with the hand grip. Preferably, the hand grip is a hand loop.

Preferably, if the hand grip is a hand loop, an upper portion of the SCBA harness includes the hand loop. Preferably, moreover, the hand loop is attached to the shoulder straps of the SCBA harness. Preferably, moreover, the hand loop and the shoulder straps are flexible straps, which are attached to one another. More preferably, the hand loop and the shoulder straps are fabric or leather straps, which are sewn to one another. The hand loop may be equivalently provided by a cloth or wire rope, which is attached to itself in a closed loop, or by a metal ring.

### BRIEF DESCRIPTION OF THE DRAWING

FIG. 1 is a simplified, fragmentary, perspective view of an SCBA harness, to which an air tank of a self-contained breathing apparatus is attached so as to enable a firefighter wearing the SCBA harness to carry the air tank on his or her back. The SCBA harness comprises two shoulder straps and, as provided by this invention, an additional strap providing a hand loop, by which a rescuer can drag a firefighter wearing the SCBA harness provided with the hand grip. FIG. 2 is a fragmentary detail illustrating an alternative attachment of the additional strap to the SCBA harness.

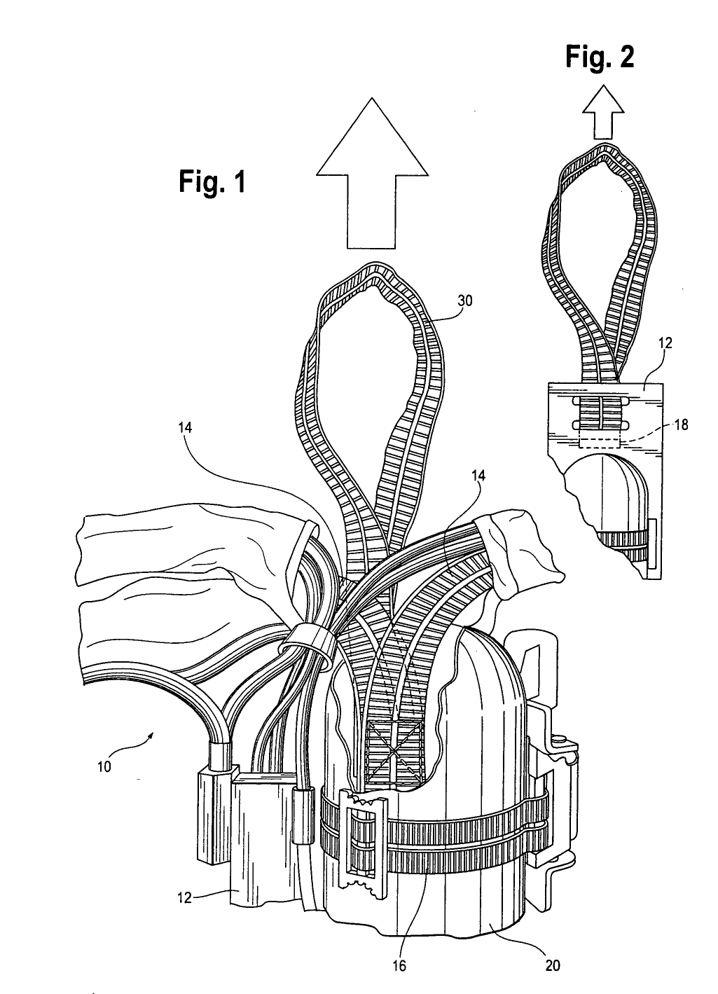

### DETAILED DESCRIPTION OF THE ILLUSTRATED EMBODIMENT

As illustrated, an SCBA harness 10, to which an air tank 20 of a self-contained breathing apparatus (SCBA) is attached so as to enable a person wearing the SCBA harness 10 to carry the air tank 20, comprises a rigid frame 12 and two shoulder straps 14, to which the air tank 20 is attached via a girding strap 16 and other attaching means. Details of said attaching means and other details of the self-contained breathing apparatus (SCBA) can be readily supplied by persons having ordinary skill in the art and are outside the scope of this invention.

In a preferred embodiment of this invention, the SCBA harness is provided with an additional strap 30, which is attached at its opposite ends 32 to the shoulder straps 14, at an upper portion of the SCBA harness 10. The additional strap 30 provides a hand loop, by which a rescuer can drag a person wearing the SCBA harness from a hazardous location, if the person becomes incapacitated. Because the additional strap 30 providing the hand loop is attached at an upper portion of the SCBA harness 10, the rescuer can drag the person in a headfirst direction. So as to assure its availability when needed to drag a person from a hazardous location, the additional strap 30 providing the hand loop is not used for any other purpose.

Preferably, the shoulder straps 14 and the additional strap 30 providing the hand loop are fabric or leather straps, fabric straps being illustrated, which are sewn to one another, as illustrated, at the opposite ends 32 of the additional strap 30. Additionally, or alternatively, the shoulder straps 14 and the opposite ends 32 of the additional strap 30 are riveted to one another. The hand loop may be equivalently provided by a cloth or wire rope, which is attached to itself in a closed loop, or by a metal ring.

In an alternative embodiment of this invention, the additional strap 30 is attached at its opposite ends 32 to an upper portion of the rigid frame 12 of the SCBA harness 10. One possible expedient to attach the opposite ends 32 of the additional strap 30 to the rigid frame 12 of the SCBA harness 10 is illustrated in FIG. 2, in which the additional strap 30 is threaded upwardly through two parallel slots 16 in the harness frame 12 and in which a metal bar 18 is fastened to the strap ends 32, the metal bar 18 being larger than the lower slot 16 so as to prevent the strap ends 32 from being pulled through the lower slot 16. Additionally, or alternatively, the strap ends 32 are riveted to the rigid frame 12 of the SCBA harness 10.

Advantageously, as improved by this invention, the SCBA harness 10 combines the utility of an SCBA harness, as described above, and the utility of a drag harness, as described above.

1. A harness attachable to an air tank of a self-contained breathing apparatus so as to enable a firefighter wearing the harness to carry the air tank, the harness including a hand grip, by which a rescuer can drag a person wearing the harness, wherein the harness has a rigid frame, to which the air tank is attachable and to which the hand loop is attached.

2. The harness of claim 1, wherein the hand grip is a hand loop.

3. The harness of claim 2, wherein an upper portion of the harness includes the hand loop.

4. The harness of claim 3 including two shoulder straps, to which the air tank is attachable and to which the hand loop is attached.

5. The harness of claim 4, wherein the hand loop and the shoulder straps are fabric or leather straps, which are sewn to one another.

6. The harness of claim 4, wherein the hand loop and the shoulder straps are flexible straps, which are attached to one another.

7. A harness attached to an air tank of a self-contained breathing apparatus so as to enable a firefighter wearing the harness to carry the air tank, the harness including a hand grip, by which a rescuer can drag a person wearing the harness, wherein the harness has a rigid frame, to which the air tank is attached and to which the hand loop is attached.

8. The harness of claim 7, wherein the hand grip is a hand loop.

9. The harness of claim 8, wherein an upper portion of the harness includes the hand loop.

10. The harness of claim 9 including two shoulder straps, to which the air tank is attached and to which the hand loop is attached.

11. The harness of claim 10, wherein the hand loop and the shoulder straps are fabric or leather straps, which are sewn to one another.

12. The harness of claim 10, wherein the hand loop and the shoulder straps are flexible straps, which are attached to one another.
